(19) United States
(12) Patent Application Publication
(10) Pub. No.: US 2020/0062162 A1
(43) Pub. Date: Feb. 27, 2020

(54) Device for Lifting and Transporting Large Game with a Vehicle or All-Terrain Vehicle

(71) Applicant: Tony Owens, Gray Court, SC (US)

(72) Inventor: Tony Owens, Gray Court, SC (US)

(21) Appl. No.: 16/552,689

(22) Filed: Aug. 27, 2019

Related U.S. Application Data
(60) Provisional application No. 62/723,159, filed on Aug. 27, 2018.

(51) Int. Cl. B60P 1/54; B60R 9/06

(52) U.S. Cl. CPC B60P 1/5471; B60R 2011/004; B60R 9/06

(57) ABSTRACT

A device that attaches to the trailer hitch of a vehicle or rack of an all-terrain vehicle, ATV, to lift and transport large game. This device uses a stationary main lift frame assembly attached to a trailer hitch mounting bracket or ATV mounting rack bracket. The assembly has a custom two-reel winch with a fixed reel and a longitudinally adjustable reel to provide two-point lifting of the animal. This arrangement provides ease of attaching and stability in carrying the load.

### FIELD OF THE INVENTION

The device relates generally to vehicle and all-terrain vehicle attachments for lifting and securing of large game for transportation.

### BACKGROUND OF THE INVENTION

Most hunters are often faced with the difficulty of lifting their large game in or on their vehicle or all-terrain vehicle, ATV, for transportation. Loading game on a vehicle is difficult due to the game not having a lifting point available for one person to lift large game into the bed of the truck or cargo area of a sport utility vehicle, SUV. This same problem presents when loading game onto an ATV rack along with no way to secure the game for transportation. In the industry, several attempts have been made to create devices for lifting and transporting game. Most of the devices are not easily used or attached to a vehicle or ATV creating strain and/or stress on the hunter. Another concern of previous devices for loading game is bleeding from the game will possibly cause stains or damage to the surface where the game is placed in or on the vehicle and/or ATV.

On the other hand, the device will allow for ease in lifting with the custom designed hoist winch. Its vehicle mounting bracket and ATV rack mounting bracket provide a quick and easy way to connect the device to the mode of transportation desired. With the choice of either mounting bracket, the main frame assembly device loads, lifts, and transports game on the exterior of a vehicle or ATV, there is no bleeding from the game causing stain to the interior of the vehicle or body of the ATV.

The following is a list of patents or patent related documents that elate generally to game lifting devices. Each of the following references is hereby incorporated herein by reference:

U.S. Pat. No. 4,806,063—Portable Wild Game Hoist

A portable wild game hoist having a multiple section boom which can be assembled and dismantled. The boom is supported at its lower end by a standard trailer hitch mounted on the rear of a vehicle. Straps are secured to the upper section of the boom and terminate in hooks at their distal ends which are adapted to mate with the edges of the fenders of the vehicle. A torsion bar is adjustably secured to one section of the boom so that is bears against the rear body or tailgate of the vehicle. A rope extends from a winch secured to the boom through a pulley at the distal end of the boom. The rope supports a hanger with hooks for supporting the animal from its rear hooves. In a further embodiment, the boom may be supported by a base resting on the ground and stabilized by the trailer hitch. In both embodiments, the boom is comprised of a plurality of mating sections

U.S. Pat. No. 5,540,537—Portable Hoist

A hoist which mounts to a trailer hitch drawbar of a vehicle includes a post connected to a tongue. The post includes an angle which defines a boom extending from a central column. The tongue includes a pivot member connected to a securing member which includes holes to allow the hoist to be secured to the trailer hitch drawbar. A brace connected between the boom and central column supports the boom, while a brace connected between the central column and the securing member supports the central column. The boom includes an eye utilized to support a block and tackle or, alternatively, a pulley utilized to support the cable of a winch mounted to the central column.

U.S. Pat. No. 5,662,451—Game Hoist

A hoist for lifting or hanging game animals. The hoist is particularly adapted for attachment to an ATV. The hoist includes a horizontal boom attached to a vertical support shaft. The vertical support shaft is telescoping to allow the height of the boom to be varied. The hoist is attached to the ATV by a base which allows the hoist to be supported in a vertical position for lifting game, and in a horizontal position for travelling. A bracing leg is also provided to prevent the ATV from tipping when heavy weights are being lifted using the hoist.

U.S. Pat. No. 6,109,855—Game Hoist and Carrier Apparatus

A hoist and carrier apparatus for securing game to a vehicle. The hoist and carrier apparatus includes a device for connecting the apparatus to the vehicle and a vertical member having a first end connected to the connecting device, a second end and a pulley wheel disposed on the second end of the vertical member. A game hoist carrier receives the game and is releasably connected to and slid cable along a length of the vertical member. A pulley is connected to and extends from the first vertical member and a cable extends from the pulley and over the pulley wheel for connecting to the game hoist carrier. When the cable is caused to be wound on the pulley, the game hoist carrier is caused to be pulled towards the vertical member and, upon being secured to the vertically extending member, slide upward along the length of the vertically extending member thereby raising any game releasably secured thereto.

U.S. Pat. No. 6,138,991—Vehicle-Mounted Hoist Apparatus

A hoist apparatus is provided for a vehicle, such as an all terrain vehicle (ATV) and includes a support bracket assembly for mounting on the vehicle. The support bracket assembly includes a horizontal support plate and a hoist-axle-reception channel depending downward from the horizontal support plate. A hoist assembly is provided and is supported by the support bracket assembly. The hoist assembly includes a hoist axle received in the hoist-axle-reception channel and includes a hoist base plate supported by the horizontal support plate. Game, such as a deer, can be supported by the hoist assembly and rotated around the support bracket assembly on the hoist axle and the hoist base plate. In accordance with one embodiment of the invention, the support bracket assembly includes mounting plates for mounting on the rear of the vehicle. In accordance with another embodiment of the invention, the support bracket assembly is mounted on a side of the vehicle. In this case, the support bracket assembly includes a horizontal support plate, and a horizontally oriented bracket-to-to-vehicle connector is connected to the horizontal support plate. A complimentary horizontally oriented vehicle-to-bracket connector is located on the vehicle for connection with the bracket-to-vehicle connector. The horizontal support plate includes a foot-reception area for receiving a foot of a driver of the vehicle. A hoist locking arm assembly is connected to the vehicle and is used to lock the hoist assembly when not in use.

U.S. Pat. No. 6,250,483—Portable Big Game Hoist/Field Processing Unit

A field hoist includes a support having a post extending upwardly therefrom. A base is slidably received over the post and is freely rotatable about an axis defined by the post. The base has a winch and pivot lock mounted thereto. The pivot lock engaging and disengaging the post and the base in a desired angular orientation with respect to the axis. An angled upright has a vertical portion which is telescopically received within the base. The angled upright has a sleeve extending upwardly atop the vertical portion at a preselected angle towards the side of the base having the winch mounted thereon. A support extension is slidably received within the sleeve and extends therefrom. A winch cable has a hook mounted at one end thereof, the other end of the winch cable being attached to the winch. The winch cable extending upwardly to the sleeve, upwardly along the sleeve and the support extension, and lastly extending downwardly from the end of the support extension. An animal hanger is provided on the hook.

U.S. Pat. No. 6,705,821—Collapsible Game Hanger for Pickup Truck

The game hanger apparatus is attachable to a tow hitch of a pickup truck. The folded game hanger can be taken to the site in the bed of the truck and speedily installed in the tow hitch for hanging, cleaning and butchering large game, such as deer and small bears. The apparatus comprises a mast and fixed boom of square cross-section, and having a winch, pulleys and a gambrel with a pair of end hooks and a pair of pins which engage a jib at the end of the boom to prevent the game from twisting. The horizontal bottom and top bars are locked in place removable pins for operation, and unlocked by removing the pins for folding the unit for storage. The bottom bar is inserted into a tow bitch and locked in place with the hitch pin.

U.S. Pat. No. 6,921,007—Hitch-Mounted Game Carrier Apparatus

A hitch-mounted game carrier apparatus for transporting and skinning game. The hitch-mounted game carrier apparatus includes a support assembly being adapted to be fastened to a hitch of a vehicle; and also includes a winch assembly being mounted to the support assembly and including a winch and a cable being carried the winch; and further includes a game carrier assembly being supported by the support assembly for carrying the game.

U.S. Pat. No. 8,231,325—Deer Loader

A deer loader includes a motor and winch plate attached to a mounting plate, which is preferably attached to a vehicle bed. A vertical stand is pivotally attached to motor and winch plate, with a pivoting arm attached to the top of the vertical stand. A winch is attached to the motor and winch plate, with a motor attached to the winch. A cable is wound around the winch and runs through a series of pulleys on the motor and winch plate, vertical stand, and pivoting arm, with an end mounted hook being attached to the cable.

U.S. Pat. No. 9,282,752—Collapsible Hitch Mounted Game Hoist Apparatus

A game hoist apparatus including a base unit attachable to the tow hitch of a vehicle, a boom and winch pulley system disposed on the base unit to attach and vertically lift a game animal for field processing. The apparatus has a swivel unit allowing the boom to rotate 360-degrees to access the game animal being processed and to load the animal into the vehicle for transport. The apparatus includes an attachable game skinning tool securable to a lower wall of a horizontal shaft of the base unit. The skinner tool has sharp skinner snatch pins to maintain one end of the animal's hide in a fixed position and to peel the hide from the animal is hoisted. The apparatus can be disassembled and collapsed into a small bundle for easy transport and storage.

U.S. Pat. No. 9,327,947—All-Terrain Vehicle Lifting Crane Apparatus

An all-terrain vehicle lifting crane apparatus is provided, having a pivotable and telescoping lifting boom and a tethered lifting hook that is powered by hand crank or by electric motor. The apparatus includes a base plate supporting an upstanding post, within which the vertical member of the lifting boom is pivotally supported therein. The lifting boom includes a telescoping structure to allow for extending its length over an article to be lifted. Both the telescoping aspect and the pivotable aspect are securable to lock the apparatus into a static configuration. The device is ideally suited for connection to an all-terrain vehicle and for lifting large game animals onto the vehicle cargo area after a hunt.

U.S. Patent Application No. US20060054580-A1—Retractable Rotating ATV Mounted Lift Boom

A retractable rotating ATV mounted lift boom for an ATV rack used to lift various objects. The invention includes a horizontal base plate and angle iron attached to the ATV rack, a horizontal female receiving tube attached onto the horizontal base plate, a horizontal elongated male piece that can be inserted and removed from the horizontal female receiving tube and a rotatable vertical elongated base piece that is perpendicularly attached to the horizontal elongated male piece. There is also a first elongated piece that is pivotally attached to the vertical elongated base piece, a second elongated piece that is pivotally attached to the first elongated piece and a third elongated piece pivotally attached to the second elongated piece.

U.S. Patent Application No. US20070092362A1—Portable Game Hoist with Folding Boom

The game hoist apparatus is attachable to a tow hitch of a pickup truck or similar vehicle. The game hoist can be taken to the site in the bed of the truck and speedily installed in the tow hitch for hanging, cleaning and butchering large game, such as deer. The hoist includes a folding tubular boom of square cross-section, and having a winch, pulleys and a spreader bar for supporting the game animal. A stabilizer fixture on the end of the boom engages the spreader bar to prevent the game from twisting. The boom is made up of two sections which are locked in place at a swivel bracket by removable pins for operation, and unlocked by removing the pins for folding the unit for storage or transit. The boom lower end is supported from an attachment bar which is inserted into a tow hitch and locked in place with the hitch pin.

U.S. Patent Application No. US20100111658A1—Apparatus for Transporting Game with an All Terrain Vehicle

An apparatus for transporting game with an all terrain vehicle is disclosed. The apparatus may be attached to the hitch of an ATV with an optional secondary attachment for an ATV rack. The apparatus uses a combined lifting and pivoting motion to raise the game from the ground and secure the game to the body of the ATV. This motion secures the game for transport and minimizes alterations to the ATVs center of mass, minimizing ATV tipping hazards when carrying heavy loads.

### BRIEF SUMMARY OF THE INVENTION

The device is a stationary main lift frame assembly with a custom two-reel winch for lifting from two points, the shoulder and hind-quarter of the animal, at the same time. The winch reels have a harness strap system for secure attachment at the two points. Each strap has a double end. The double end allows for looping one end around the shoulder and the other between the legs connecting to a sliding d-ring on the main strap. The second strap connects to the hind-quarter of the game in the same way, one around the body and the other between the two legs, connecting to the sliding d-ring. As both straps are lifted the sliding d-ring tightens. This strap design secures the load and evenly lifts it to the lift frame. The stationary main frame assembly has connection points for extra strapping and securing of the load. The connection points can also be used as securing points for the device to other locations on a vehicle or ATV. The device is attached and detached quickly through a telescoping assembly and then inserting a quick connect pin to a trailer hitch mounting bracket or ATV rack bracket. This arrangement allows a user to remove the device quickly from a vehicle for placement on an ATV or for storage. The trailer hitch bracket attaches to a vehicle or ATV by means of a slide-in hitch mount and quick connect pin. An ATV rack mount is available if the ATV is not equipped with a slide-in hitch. The ATV rack mount attaches directly to the ATV rack for a quick connection of the stationary main frame assembly.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of a removable attachment for a vehicle for lifting and transporting game animals and the like;

FIG. 2 is an exploded view of one embodiment of a removable attachment for a vehicle for lifting and transporting game animals and the like;

FIG. 3 is an exploded view of another embodiment of a removable attachment for a vehicle for lifting and transporting game animals and the like;

FIG. 4 is a photograph of one embodiment of a removable attachment for a vehicle for lifting and transporting game animals and the like, wherein the attachment is connected to a truck;

FIG. 5 is a photograph of one embodiment of a removable attachment for a vehicle for lifting and transporting game animals and the like, wherein the attachment is connected to a truck, and wherein a deer is attached thereto;

FIG. 6 is a photograph of one embodiment of a removable attachment for a vehicle for lifting and transporting game animals and the like, wherein the attachment is connected to an ATV; and

FIG. 7 a photograph of one embodiment of a removable attachment for a vehicle for lifting and transporting game animals and the like, wherein the attachment is connected to an ATV, and wherein a deer is attached thereto.

### DETAILED DESCRIPTION OF THE INVENTION

### Overview

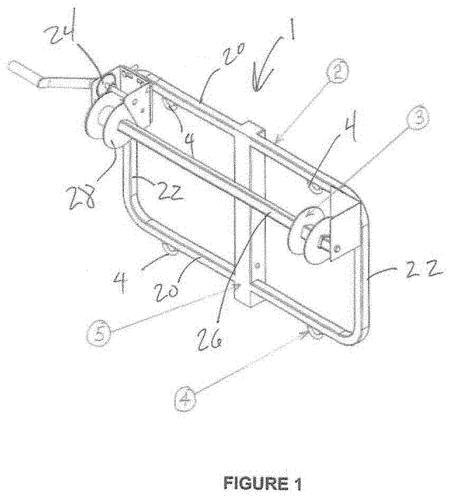

FIG. 1 illustrates the primary view of the lifting mechanism. The winch lifting system 1 comprises, in a first embodiment, a lift frame member 2 having one stationary reel 28 combined with an adjustable reel 3. In this embodiment, the lift frame member 2 includes a pair of horizontal supports 20 connected to a pair of outer vertical supports 22, and preferably forms a generally rectangular shape with curved corners.

The two reels and winch 24 are attached to the lift frame member 2 at opposed upper corners of the frame member 2. The two reels are designed for a double end strap to be attached for lifting the game from a two point contact, so that one strap attaches to each reel. A rotating axle 26 connects the two reels, so that they rotate at the same rate, and the adjustable reel may slide in a longitudinal direction along the rotating axle, and optionally, may be removably locked into any desired position along said axle, in order to accommodate game animals of various sizes. This assembly lifts the game evenly off is the ground in a horizontal position. The double ended straps provide a secure harness type connection to the game, such as a deer. Four “U” shaped loops 4 are attached to the frame for extra strap connection points. A vertical mounting tube 5 is connected to the center of the frame 2 that slide over the mounting brackets.

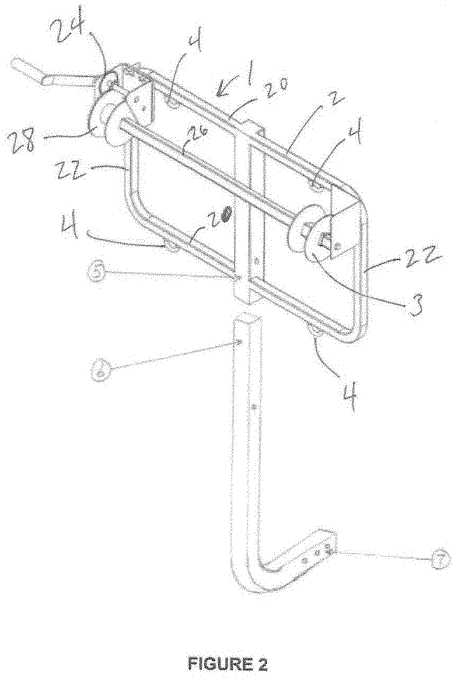

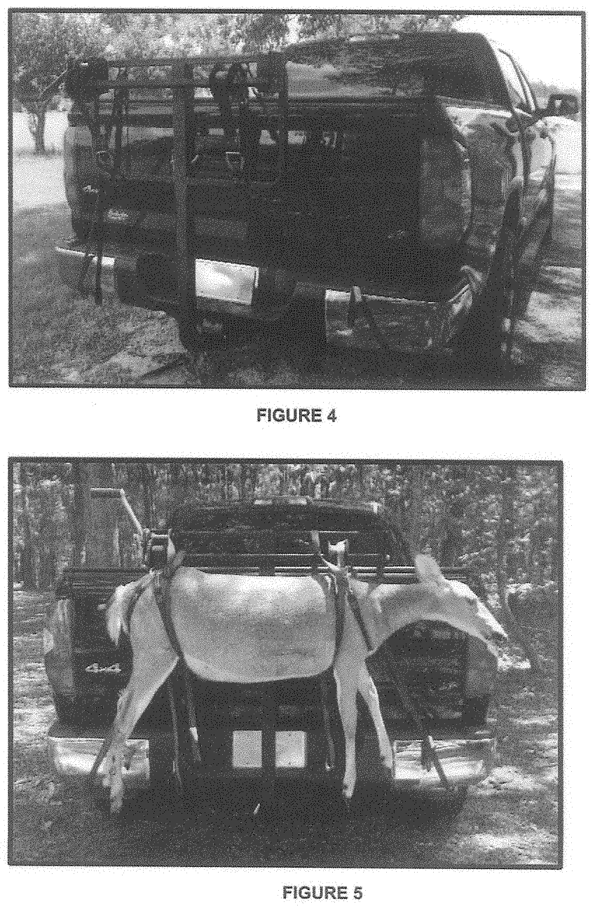

FIGS. 2, 4 and 5 show one embodiment of the lift that is adapted for mounting of the lift system 1 to a hitch mount. The tubing frame 6 attaches to a trailer hitch mount in the typical manner, and the lift frame member 2 attaches to the tubing frame 6 by sliding the vertical mounting tube 5 over the tubing frame 6, aligning holes between the tubing frame 6 and the vertical mounting tube 5, and sliding a pin through the aligned holes. The mounting end 7 of the tubing frame 6 slides into to the trailer hitch mount of the vehicle, and a pin may be used to slide through aligned holes in the trailer hitch mount of the vehicle and the mounting bracket hitch 7. Although these telescoping components are described as being removably attached together using a pin through aligned holes, it should be understood that other mounting means and securing means may be used to removably attach these components together, as is well-known in the art.

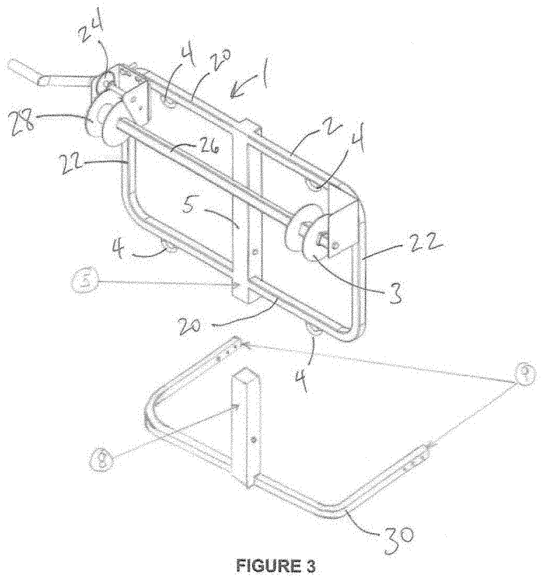

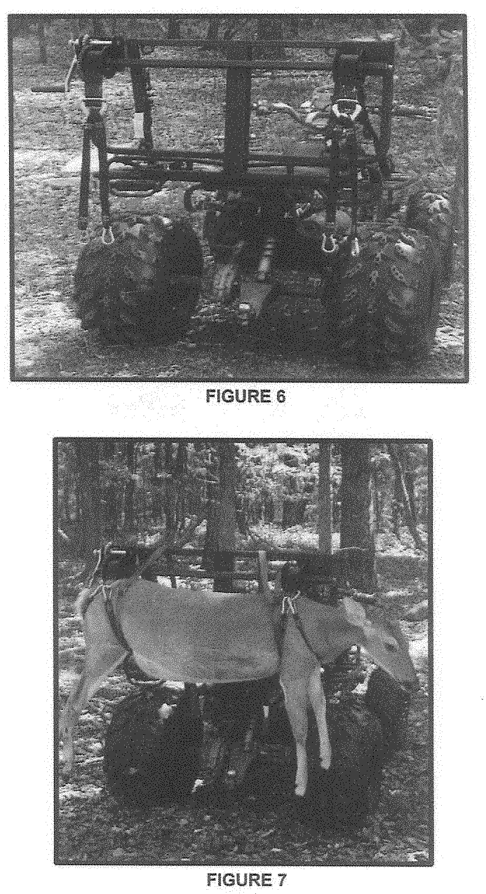

In another embodiment, as shown in FIGS. 3, 6 and 7, an ATV mounting bracket 30 for an ATV rack includes a vertical post 8. The ATV mounting bracket 30 is in a generally U-shaped configuration that fits around the perimeter of a rear ATV rack. The distal ends 9 of the ATV mounting bracket 30 may be attached to the sides of the rear ATV rack via screws, bolts, or any other suitable attachment means.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Although the present invention has been described in detail with reference to particular embodiments and dimensions, the embodiments are for illustrative purposes only and do not limit the invention. It is to be appreciated that those skilled in the art can change or modify the embodiments without departing from the scope and spirit of the invention. It is to be understood that the inventive concept is not to be considered limited to the constructions and dimensions disclosed herein.

1. A game animal lifting sport assembly comprising:
a lift frame member
a winch assembly attached to said lift frame member, said winch assembly comprising a winch, a rotating axle having a first end and a second end attached to said winch, a first reel attached to said first end of said rotating axle, and a second reel attached to said rotating axle, so that when said winch is rotated, said axle and said reels rotate together with said winch;
a first strap connected to said first reel;
a second strap attached to said second reel; and
means for removably attaching said game animal lifting and transport assembly to a vehicle.

2. The game animal lifting and transport assembly set forth in claim 1, wherein said second reel is adjustable, so that it may slide longitudinally along said axle and be removably secured in any desired position.

3. The game animal lifting and transport assembly set forth in claim 1, wherein said means for removably attaching said game animal lifting and transport assembly to a vehicle comprises a tubing frame having an L-shape, wherein a first end of said tubing frame is adapted to received into a trailer hitch receiver of a vehicle, and wherein a second end of said tubing frame slides telescopically into a vertical mounting tube attached to said lift frame member.

4. The game animal lifting and transport assembly set forth in claim 1, wherein said means for removably attaching said game animal lifting and transport assembly to a vehicle comprises a horizontally oriented U-shaped ATV mounting bracket attached to a vertical support, and wherein said vertical support is adapted to telescopically engage with a vertical mounting tube attached to said lift frame member.

5. The game animal lifting and transport assembly set forth in claim 1, wherein said lift frame member comprises a pair of horizontal supports having first and second ends, and a pair of outer vertical supports having a top and bottom end, wherein said ends of said outer vertical supports are connected to said ends of said horizontal supports to form a generally rectangular shape, and wherein said lift frame member further includes a vertical mounting tube attached to a central portion of said lifting frame member.

6. The game animal lifting and transport assembly set forth in claim 5, further including at least two U-shaped loops attached to said horizontal supports, wherein said U-shaped loops may be used to attach said straps thereto.
